(19) United States
(12) Patent Application Publication
(10) Pub. No.: US 2012/0173731 A1
(43) Pub. Date: Jul. 5, 2012

(54) SYSTEM AND METHOD FOR STARTING CLOUD COMPUTING SERVICE ACCORDING TO USER LOCATION

(75) Inventors: Hsiu Min Lin, Taoyuan County (TW); Hsiao Feng Yeh, Taoyuan County (TW); Cheng Ju Yu, Taoyuan County (TW); Chih Cheng Chien, Taoyuan County (TW); Peng Yi Lai, Taoyuan County (TW)

(73) Assignee: CHUNGHWA TELECOM CO., LTD., Taoyuan County (TW)

(21) Appl. No.: 13/339,383

(22) Filed: Dec. 29, 2011

(30) Foreign Application Priority Data
Dec. 29, 2010 (TW) 099146505

(51) Int. Cl. G06F 15/173

(52) U.S. Cl. 709/226

(57) ABSTRACT

A system and a method for starting a cloud computing service according to a user location are disclosed, the system comprises an authentication server, a central management server, a central database management server, a central storage server, a local management server, a local computing server, and a local storage server to determine a user access location, and to distribute cloud computing resources, thereby providing a simple, convenient and efficient cloud computing service.

### BACKGROUND OF THE INVENTION

1. Field of the Invention

The present invention relates to a system and a method for starting a cloud computing service according to a user location, and more particularly, to a system and a method which can combine a broadband access server, a central management server, and a local management server for determining a network access location, starting a cloud service, centrally managing a snapshot unit, and distributing a computing resource of the cloud computing service, thereby providing a simple, convenient and efficient cloud service.

2. Description of the Prior Art

For corporate using a lot of personal computers (PCs) for business operations, it is troublesome to manage all the PCs since it involves maintaining and upgrading hardware devices, installing and upgrading operating system/applications, storing user data backups and so on; it becomes even more complicated for the company because each computer hosts its own hardware and software, which means a heavy burden and high maintenance costs to the company.

In modern information technology field, the cloud computing concept is proposed with desktop virtualization technique to solve the PC management problem. In cloud computing, the desktop environment of a PC user can be stored remotely at a cloud service server through a desktop virtualization technique, making it possible for the user to access the same applications, personal data and system profile at different locations or user devices and to use the computing resource at the central computer room to perform computing tasks.

Although the desktop virtualization technique can reduce the PC management efforts and maintenance costs through centralized management; it takes a great deal of time sending/receiving the contents and commands between the central server and the user device when the user is far away from the central computer room, and often leads to slow application responses.

In a traditional cloud computing environment, all computing resources are centralized in the central computer room, problems such as network congestion and slow response time could occur when a lot of users are using the cloud service at the same time. Furthermore, when the central computer room fails to provide cloud services due to any unusual incidents or emergencies, users can't have accesses to the cloud service and may file complaints against the service provider.

Additionally, the virtual desktop environment could be damaged by human operation errors or malware if not safely guarded, and thus becomes inaccessible to users.

Therefore, the tradition cloud computing environment presents several shortcomings to be overcome. In view of the deficiencies of the prior art techniques, after years of constant researches, the inventor has successfully proposed a system and a method for starting a cloud computing service according to a user location in the present invention.

### SUMMARY OF THE INVENTION

A system for starting a cloud computing service according to a user location comprises a cloud service central computer room and a cloud service local computer room, wherein the cloud service central computer room comprises an authentication server, a central management server, a central database management server, a central storage server, and the cloud service local computer room comprises a local management server, a local computing server, and a local storage server.

### BRIEF DESCRIPTION OF THE DRAWINGS

The drawings disclose an illustrative embodiment of the present invention which serves to exemplify the various advantages and objects hereof, and are as follows:

FIG. 1 illustrates a structural view of a system for starting a cloud computing service according to a user location;

FIG. 2 illustrates a flow diagram of starting the cloud service of the present invention; and

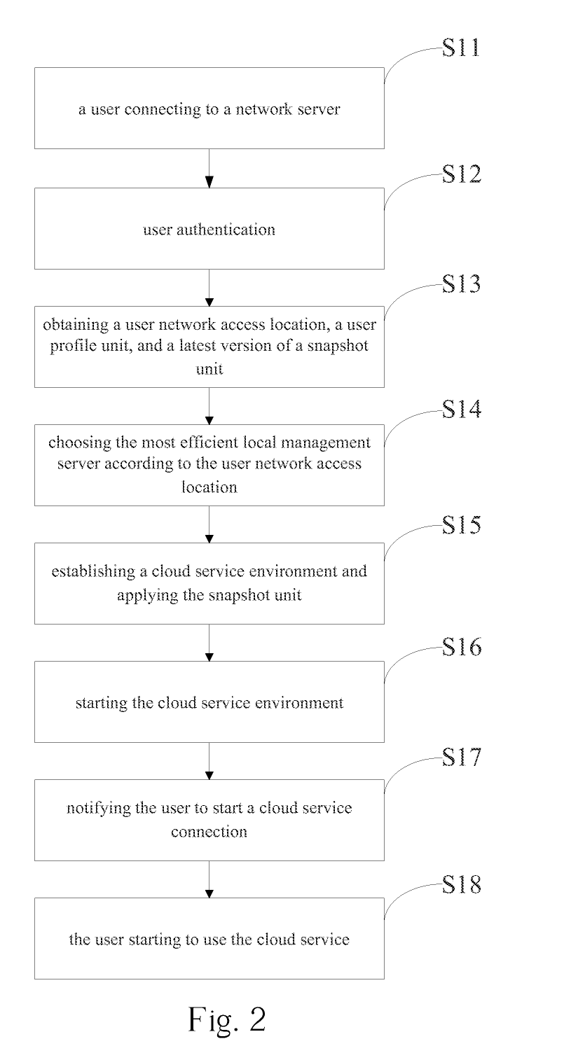

FIG. 3 illustrates a flow diagram of closing the cloud service of the present invention.

### REFERENCE NUMERALS

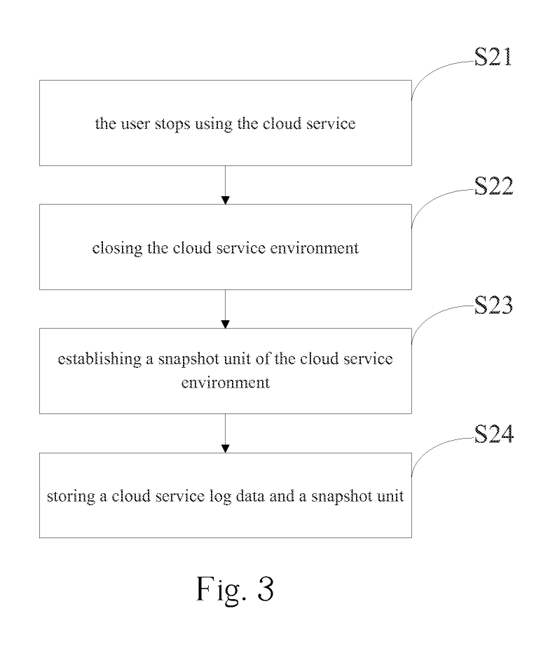

11 user device
20 broadband network access office
21 broadband remote access server
30 cloud service central computer room
31 authentication server
32 central management server
33 central database management server
34 central storage server
35 user profile unit
36 snapshot unit
40 cloud service local office
41 local management server
42 local computing server
43 local storage server
44 storage unit
45 template
46 local snapshot unit
S11 a user connecting to a network server
S12 user authentication
S13 obtaining a user network access location, a user profile unit, and a latest version of a snapshot unit
S14 choosing the most efficient local management server according to the user network access location
S15 establishing a cloud service environment and applying the snapshot unit
S16 starting the cloud service environment
S17 notifying the user to start a cloud service connection
S18 the user starting to use the cloud service
FIG. 3
S21 the user stops using the cloud service
S22 closing the cloud service environment
S23 establishing a snapshot unit of the cloud service environment
S24 storing a cloud service log data and a snapshot unit

### DETAILED DESCRIPTION OF THE PREFERRED EMBODIMENT

The present invention discloses a system and a method for starting a cloud computing service according to a user location, in which a set of a broadband remote access server and a central management server is used for providing the most efficient local management server for a user to use a cloud service, and for centrally managing a user profile and snapshot unit so as to both increase the performance of the cloud service and safeguard the user data. The method comprises the steps of starting a browser to connect to an authentication page for verifying a user ID and obtaining a user network access location, selecting the most efficient local management server according to the network access location, obtaining a profile unit and a snapshot unit and transmitting them to the local management server, establishing a cloud service environment and applying the snapshot unit, starting the cloud service environment, notifying the user to start a cloud service connection, closing the cloud service environment, establishing a new snapshot unit and transmitting the snapshot unit to the central management server, and storing a log data of the cloud service to a central database.

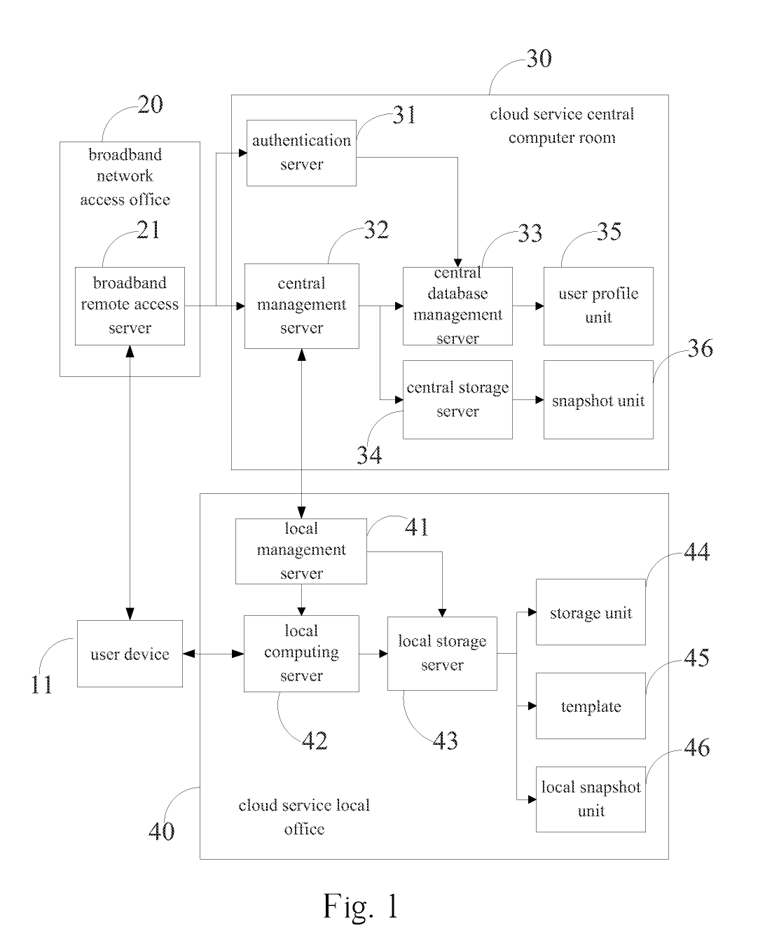

FIG. 1 illustrates a structural view of a system for starting a cloud computing service according to a user location, wherein the system comprises:

a user device 11, with which the user uses to connect to the Internet to access a cloud service, the user device can be a personal computer, notebook computer, smart phone, or a thin client device;

a broadband network access office 20 for storing a broadband remote access equipment to provide Internet services;

a broadband remote access server 21 for connecting the user device to a network of an internet service provider;

a cloud service central computer room 30 for storing a central management server for centrally managing cloud service settings and records;

an authentication server 31 for verifying a user of the user device 11;

a central management server 32 for managing personalized data and snapshot data of a user, and choosing the most efficient local management server for providing a cloud service to the user;

a central database management server 33 for storing profile data and log data of the user, a location and system configuration of the local management server

a central storage server 34 storing a snapshot unit;

a user profile unit 35 for recording settings related to system configuration, which includes an operation system version, a central processing unit type, a memory volume, and a storage space volume;

a snapshot unit 36 for storing a snapshot of the virtual desktop environment and its establishing time;

a cloud service local computer room 40 for storing a local management server to provide a resource for the cloud service;

a local management server 41 for managing operations of establishing, starting and closing the virtual desktop environment of the user, and distributing a computing resource of the cloud service local computer room to perform the virtual desktop environment of the user;

a local computing server 42 for providing the computing resource to perform the virtual desktop environment of the user;

a local storage server for storing a storage unit, a template, and a local snapshot unit of the user;

a storage unit 44 for storing an operating system, an application, an configuration, and a user data of the virtual desktop environment;

a template 45 for storing basic data of the operating system, the application, and the configuration of the virtual desktop environment;

a local snapshot unit 46 for storing a snapshot and establishing time of the virtual desktop environment.

The broadband remote access server 21 is located in the broadband network access office 20, when a user uses the user device 11 to start a browser to make a network connection request, the broadband remote access server 21 sends an authentication page to the user device 11, after the user inputs a username and a password, the broadband remote access server 21 transmits the user and the password to the authentication server 31 of the cloud service central computer room 30 for authentication, after the username and password are verified, the broadband remote access server 21 transmits user data and a network access location to the central management server 32 in the cloud service central computer room 30; the central management server obtains a user profile unit 35 from the central database management server 33 according to the user ID, and obtains a latest version of the snapshot unit 36 from the central storage server 34, the central management server obtains a local management server 41 which meets user requirements and has the shortest distance to the user according to a user network access location;

the central management server 32 transmits the user profile unit 35 and the snapshot unit 36 to the local management server 41 in the cloud service local computer room 40; the local management server 41 chooses a template 45 which meets user requirements from the local storage server 43 according to the user profile unit 35; the local management server 41 establishes a storage unit 44 of the user according to the template 45 and applying the snapshot unit 36; the local management server 41 distributing a computing resource to start the virtual desktop environment of the user according to a usage condition of the local computing server 42; the local management server 41 transmits a cloud service started message to the central management server 32 for the central management server 32 to store a cloud service started record to the central database management server 33; the central management server 32 transmits a cloud service network connection page to the user device for the user to start a remote connection to a virtual desktop environment to start using the cloud service.

When the user stops using the cloud service and closes the virtual desktop environment, the local management server 41 establishes a snapshot unit 36 of the virtual desktop environment and stores the snapshot unit 36 to the local storage server 43, the local management server 41 transmits a cloud service closed message and the snapshot unit 36 to the central management server 32; and the central management server 32 storing a cloud service closed record to the central database management server 33 and a latest version of the snapshot unit 36 to the central storage server 34.

The present invention provides a system and method for starting cloud computing service according to user location, while compared with prior art techniques, is advantageous in:

1. In the present invention, the broadband network access office monitors the network access location of the user and works with the local management server and the local computing server to provide the most efficient cloud service to the user, thereby reducing the data transmission time and providing a viable, reliable and highly efficient way for starting the cloud service.

2. In the present invention, the central computer room centrally manages the user profile unit, a log data, and a version of the snapshot unit of the user; the local computer room provides computing resources, manages the startup and closing of the cloud service environment to realize central management and distributed computing.

3. The present invention uses existing broadband network access office and broadband network access equipment to not only reduce setup costs and to further ensure the stability and reliability of the cloud service, thereby preventing the problem of computing resource overly centralized in the central computer room to avoid the possibilities of network congestion and single point of failure. Besides, the present invention can improve the overall maintenance efficiency and provide high economic effects.

4. The present invention can record the user log data for the cloud service and saves every version of the snapshot unit of the virtual desktop, when the virtual desktop fails to function normally and causes data loss, it is viable to use the snapshot unit to recover the virtual desktop for normal operation.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A system for starting a cloud computing service according to a user location, comprising:
a cloud service central computer room;
wherein the cloud service central computer room stores a central management server for centrally managing settings and records and comprises:
an authentication server for verifying a user ID;
a central management server for managing personalized data and snapshot data of a user, and choosing the most efficient local management server for providing a cloud service to the user;
a central database management server for storing profile data and log data of the user, a location and system configuration of the local management server; and
a central storage server for storing a snapshot unit;
a cloud service local computer room;
wherein the cloud service local computer room stores a local management server for providing a computing resource for the cloud service and comprises:
a local management server for managing operations of establishing, starting and closing a virtual desktop environment of the user, and distributing a computing resource of the cloud service local computer room to perform the virtual desktop environment of the user;
a local computing server for providing the computing resource to perform the virtual desktop environment of the user; and
a local storage server for storing a storage unit, a template, and a local snapshot unit of the user.

2. The system for starting a cloud computing service according to a user location as claimed in claim 1, wherein the local storage server comprises:
a storage unit for storing a operating system, an application, an configuration, and a user data of the virtual desktop environment;
a template for storing basic data of the operating system, the application, and the configuration of the virtual desktop environment; and
a local snapshot unit for storing a snapshot and establishing time of the virtual desktop environment.

3. The system for starting a cloud computing service according to a user location as claimed in claim 1, wherein the central management server obtains a user profile unit from the central database management server according to the user ID, a latest version of the snapshot unit from the central storage server, and a local management server which meets user requirements and has the shortest distance to the user according to a user network access location; the central management server transmits the user profile unit and the snapshot unit to the local management server of the cloud service local computer room, after receiving a cloud service started message from the local management server, the central management server transmits a cloud service network connection page to a user device.

4. The system for starting a cloud computing service according to a user location as claimed in claim 1, wherein the local management server chooses a template which meets user requirements from the local storage server according to the user profile unit, establishes a storage unit of the user according to the template and applies the snapshot unit, the local management server distributes a computing resource to start the virtual desktop environment of the user according to a usage condition, and the local management server transmits the cloud service started message to the central management server.

5. A method for starting a cloud computing service according to a user location, comprising:
a. a broadband remote access server in a broadband network access office transmitting a user ID authentication page to a user device in response to a user using the user device to start a network connection request via a browser;
b. the broadband remote access server transmitting a user name and password to an authentication server in a cloud service central computer room for authentication, when the user name and password are verified, the broadband remote access server transmitting user data and a network access location to a central management server in the cloud service central computer room;
c. the central management server obtaining a user profile unit from the central database management server according to the user ID, and obtaining a latest version of the snapshot unit from the central storage server;
d. the central management server obtaining a local management server which meets user requirements and has the shortest distance to the user according to a user network access location;
e. the central management server transmitting the user profile unit and the snapshot unit to the local management server in the cloud service local computer room;
f. the local management server choosing a template which meets user requirements from the local storage server according to the user profile unit;
g. the local management server establishing a storage unit of the user according to the template and applying the snapshot unit;
h. the local management server distributing a computing resource to start the virtual desktop environment of the user according to a usage condition of the local computing server;
i. the local management server transmitting a cloud service started message to the central management server for the central management server to store a cloud service started record to the central database management server;
j. the central management server transmitting a cloud service network connection page to the user device for the user to start a remote connection to a virtual desktop environment of the cloud service;
k. when the user stops using the cloud service and closes the virtual desktop environment, the local management server establishing a snapshot unit of the virtual desktop environment and storing the snapshot unit to the local storage server, and the local management server transmitting a cloud service closed message and the snapshot unit to the central management server; and
l. the central management server storing a cloud service closed record to the central database management server and a latest version of the snapshot unit to the central storage server.

6. The method for starting a cloud computing service according to a user location as claimed in claim 5, wherein the user location is obtained by comparing and analyzing the user name and password and the network connection request received by the broadband remote access server.

7. The method for starting a cloud computing service according to a user location as claimed in claim 5, wherein the broadband network access office monitors the network access location of the user and works with the local management server and the local computing server to provide the most efficient cloud service to the user, thereby reducing the data transmission time and providing a viable, reliable and highly efficient way for starting the cloud service.

8. The method for starting a cloud computing service according to a user location as claimed in claim 5, wherein the central computer room centrally manages the user profile unit, a log data, and the snapshot unit of the user and works with the local computer room to realize central management and distributed computing, thereby solving the problem of computing resource overly centralized in the central computer room.
